(19) United States
(12) Patent Application Publication
(10) Pub. No.: US 2010/0027773 A1
(43) Pub. Date: Feb. 4, 2010

(54) TELEPHONE APPARATUS

(76) Inventors: Richard Frederick Wallis, Gloucestershire (GB); Samuel David Wilson, Oxfordshire (GB)

Correspondence Address: Roylace Abrams Berdo & Goodman, 1300 19th Street, NW Suite 600, Washington, DC, 20036-2680, US

(21) Appl. No.: 12/311,498

(22) PCT Filed: Sep. 26, 2007
(86) PCT No.: PCT/GB2007/050584

§ 371 Date: Apr. 1, 2009

(30) Foreign Application Priority Data
Oct. 3, 2006 (GB) 0619449.2

(51) Int. Cl. H04M 3/42; H04M 1/00

(52) U.S. Cl. 379/201.01; 379/419

(57) ABSTRACT

A telephone apparatus has a base station (1) with a connection to a PSTN line (11), and a handset (2) connectable with the base station and to the PSTN therethrough. A memory stores a database of telephone numbers each associated with a picture, and a processor enables downloading of a picture to the database. An input device (18) enables the picture to be associated with a telephone number and the telephone number to be saved in the database in association with the picture. A display (18) displays pictures/and or numbers from the database by means of a selector such a scroll wheel (24) and a dialling initiator such as a key (21) causes the telephone apparatus to dial the number associated with the picture displayed on the display.

The present invention relates to telephone apparatus and, more particularly, telephone apparatus for attachment to the public system telephone network (PSTN) having fixed or wired connections.

With an increase in the ageing population of the world there is a growing need for products and services that allow people to continue to enjoy their lives by providing easy to use and simple to understand products despite their failing senses or failing dexterity. In particular, telephones provide difficulties for many of the older generation, partly because of the size of the keys, but also because of the difficulty of locating and reading the numbers required for dialling. Attempts to overcome these problems have included enlarged keys and keypads, memory dialling etc.

Nevertheless, the existing apparatuses do not solve the many difficulties which exist and there is a need for simpler and easier-to-use apparatuses.

According to the present invention there is provided a telephone apparatus including a base station having a connection to a PSTN line; a handset connectable with the base station and to the PSTN therethrough; a memory for storing a database of telephone numbers each associatable with a picture; a processor for downloading a picture to the database; an input device for associating a picture with a telephone number and saving the telephone number in the database in association with the picture; a display arranged to display each pictures sequentially from the database; a selector for selecting a picture from the database for display on the display; and a dialling initiator for causing the telephone apparatus to dial the number associated with the picture displayed on the display.

Preferably the apparatus also includes a digital camera connectable or connected with the base station. The digital camera may be provided as an integral part of the base station or the handset or else it may be a separate component which can be attached to the base station to enable download of pictures stored therein under the control of the processor.

It will readily be appreciated that such an apparatus can make it simple for elderly or handicapped people to dial a desired number without having to enter each of the required digits, simply by scrolling through the pictures until the desired one is displayed.

The handset preferably has a radio module for connection to the base station via a corresponding radio module and may include a charging connector and a rechargeable battery, the base station including a corresponding charging port to enable charging of the rechargeable battery in the handset when the handset is docked in the base station. Alternatively, the handset may have a cable connection to the base station.

The memory storing the database may be disposed in the base station, particularly if the handset is connected via a cable, but preferably the memory is disposed in the handset, particularly when the handset has a wireless connection to the base station. For security and back-up purposes, a memory containing the database may be provided in each of the handset and the base station and the memories synchronised when the handset is docked with the base station.

Preferably, the camera is removable from the base station. It may be disposed in the handset or may be a separate component altogether. However, it may alternatively be permanently mounted in the base station.

The input device preferably comprises a touch-screen facility integrated with the display, but may alternatively comprise a keypad.

The display may be disposed in the handset or in the base station or both.

The selector preferably comprises a scroll wheel on the handset, but may be provided as ‘up’ and ‘down’ keys if desired. Alternatively, the selector includes a scroll function on the touch-screen display.

Preferably, the dialling initiator is a key but it may also or alternatively be provided as part of a touch screen facility on the handset's display.

A keypad may be provided for number-initiated dialling or else the screen can be arranged to display, selectively, a keypad for on-screen touch dialling.

The base station preferably includes a data port for external connection to a memory device or to computer, for example in the form of a USB port or an Ethernet (RJ45) port.

An audible alarm and a key dedicated to an emergency services number may be provided, the audible alarm being caused to sound when the key has been pressed for a predetermined period of time.

One example of a telephone apparatus according to the present invention will now be described with reference to the accompanying diagrammatic drawings, in which:

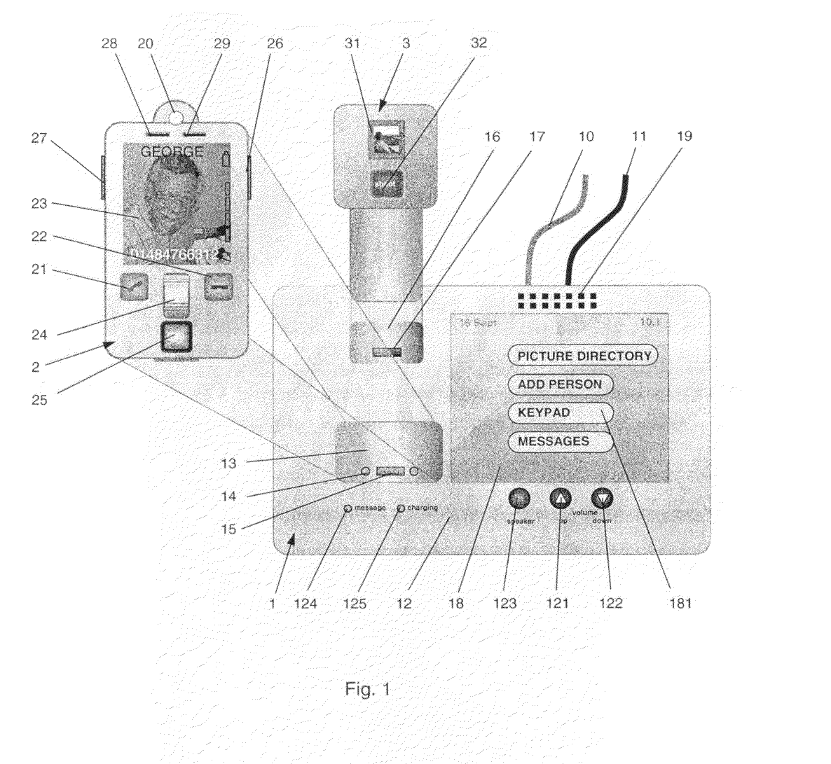

FIG. 1 shows, with indications as to how the parts cooperate, a telephone base station 1 which has a cordless handset 2 and a removable digital camera 3; and

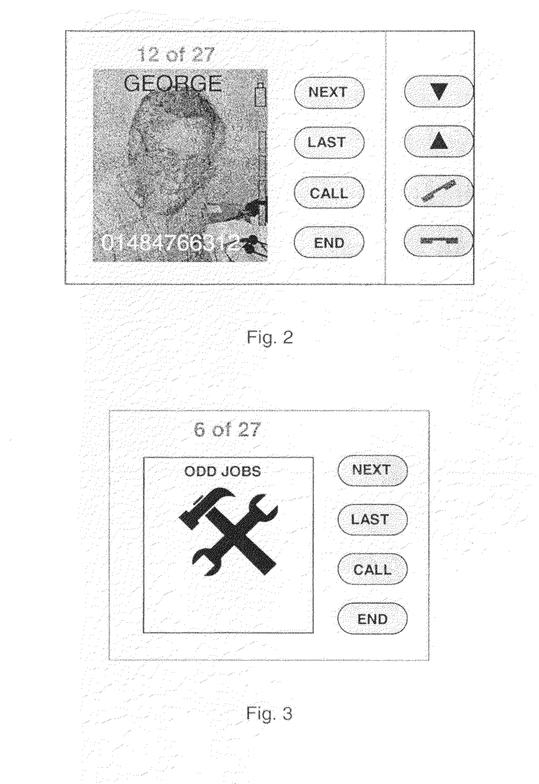

FIGS. 2 to 8 show a display in various modes of use.

The base station 1 has a power lead 10 and a PSTN (phone line) lead 11 for connecting the base station to the public telephone network. (in an alternative example, the lead 11 may be replaced by a wired connection of the base station to a personal computer or a TCPIP router, for ‘voice of IP’ (VoIP) operation via the Internet. A housing 12 has a charging cradle 13 for receiving the cordless handset 2 and has charging terminals 14 as well as a data port 15. The base station also includes a docking cradle 16 with a data port 17 for connection of the digital camera 3. A colour display 18 of the touch screen type is provided as an interface with a processor (not shown) but located within the base station. A microphone 19 is provided to allow hands-free speaking using the base station 1, alone, which is useful if the handset is elsewhere. Volume controls in the form of ‘increase’ and ‘decrease’ keys 121,122 are provided as well as a speaker on/off button 123 to implement hands-free operation. Furthermore, “message waiting” and “charging” indicators in the form of LEDs 124,125 are provided to indicate, respectively, receipt of a message on a voice message store within the telephone base station 1 and charging of handset batteries from the power provided to the base station. The ‘message waiting’ indication may also be provided on the display 18 if desired.

The data ports 15 and 17 allow the transmission of image files containing pictures between the camera 3, the base station 1 and the handset 2 under the control of the processor within the base station, operated by use of the touch-screen 18 which has appropriate functionality to access a picture directory, add a new picture or select a touch-screen alpha-numeric keypad for number entry, name entry etc. If desired, the base station 1 may include a text-to-speech translation chip. The base station voice message store which can be accessed through the touch screen 18. Different ring tones may be provided for association with different telephone numbers or pictures stored in a database in the handset 2 and/or the base station 1 to allow easy identification of the person calling in.

The digital camera 3 is a simple digital camera with limited functionality to enable the taking of portrait photographs which can then be saved in the database. A small display 31 is provided as well as the required lens (not shown as it is to the rear in this example), together with a key 32 to trigger the taking of a photograph. It is envisaged that the data port 17 will provide for images to be uploaded from a conventional memory stick (RAM) having say a USB connection which may either be the data port 17 or a separate port (not shown). Although the camera 3 is shown to have a docking position normally behind the handset, this position may vary from example to example as, of course, will the detailed design of the external appearance of the apparatus.

Additional functionality may be provided by an optional connection to a personal computer for manipulation of images or the database of photographs held within the telephone apparatus.

The handset 2, which is preferably wirelessly connected to the base station 1 using the DECT protocol, has a belt clip (not shown as it is on the rear) together with a loop 20 for connection of a lanyard or the like and has a key 21 for initiating a call to the number related to the picture displayed (or else to the number displayed if there is no associated picture stored in the database), a key 22 for ending a call, a display 23 for displaying pictures (which may be photographs) stored in the database within the handset and/or the base station and also for displaying names and telephone numbers associated with the pictures, as well as a scroll wheel 24 which allows for scrolling between pictures stored in the database (which may either be in the handset or else in the base station or which may be replicated in both for additional functionality and back-up purposes). A keypad lock 26 may be provided on the handset 2 to prevent inadvertent use and a dedicated emergency telephone number key 25 is provided which when pressed and held for a predetermined length of time, can be arranged to call the emergency services telephone number automatically. Preferably operation of the key 25 also causes an audible signal from the handset and vibration to reassure the user that the call has been made. A volume control 27 is provided as well as a speaker and microphone 28,29. Hands-free operation of the handset when it is remote from the base station may be provided for example by holding down the make-call key 21 during a call.

A simple-to-use interface is provided by way of the touch-screen display 18 to enable pictures to be transferred from the camera 3 or from say a USB memory card or similar or else directly from a personal computer (PC) to the database. The display 18 displays a single picture. Access to the picture directory allows an up and down scrolling through pictures held in the database. The database may be pre-loaded, before use, with stylised pictures corresponding to frequently-used services such as a doctor, hairdresser, care worker, taxi etc., so that telephone numbers can be entered, again via the keypad on the touch-screen, to store both a telephone number and a name in the database associated with the corresponding picture. Through the touch-screen options may be provided to save a picture transferred to the base station screen from either the camera, a memory stick or a PC.

The display 18 initially displays the menu 181 shown in FIG. 1 and the screen and processor are arranged to operate such that touch-screen operations function as follows:
Picture Directory takes the user directly to the picture gallery/directory
Add person allows the addition of a picture
Keypad allows a number to be dialled directly through the touch screen display
Messages allows up to six messages to be displayed and retrieved

The ‘directory’ screen view is shown in FIG. 2 and is simply a scroll up and down function showing each stored image with a name and number. When the right picture is found the call can be made either by touching the picture or by pressing the ‘call’ key and ended using the ‘end’ key or by tapping the picture again.

A number of pre-determined images to prompt the user (eg GP, pharmacy, hairdresser, care worker, taxi, Social Services etc) can be displayed as well, for example as shown in FIG. 3.

The default page may displays just date and time and a clock but when touched, to enter the directory the picture, name, number and number of pictures is displayed

The simple sequence is touch ‘directory’, scroll up or down, touch ‘call’ or the picture, then ‘end call’ or touch the screen again.

If desired, a sorting routine may help to prioritise numbers or the pictures are automatically re-ordered each month based on frequency of use.—ie touch ‘directory’ and the most frequently called number is the default picture, scrolling down give the next most frequently used and so on.

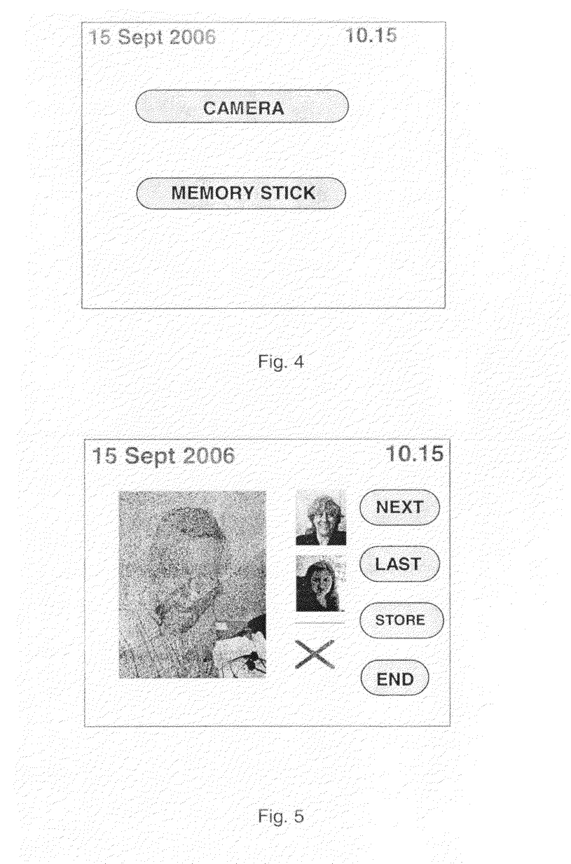

To install a picture, name and number, the ‘add person’ option is used from the main screen menu and the resulting menu choices (see FIG. 4) allows the user to select where to get the picture from, either:
the camera when the camera is stowed in its base station holster, or
from a memory stick using the USB port

The selection will bring pictures onto the screen (see FIG. 5) and the options allow the user to scroll through the pictures stored in the camera or memory stick and then to store them. The selected picture is then displayed with a prompt to assign a name and number. If no picture is present a cross is shown to denote the end of the ‘filmstrip’ or directory.

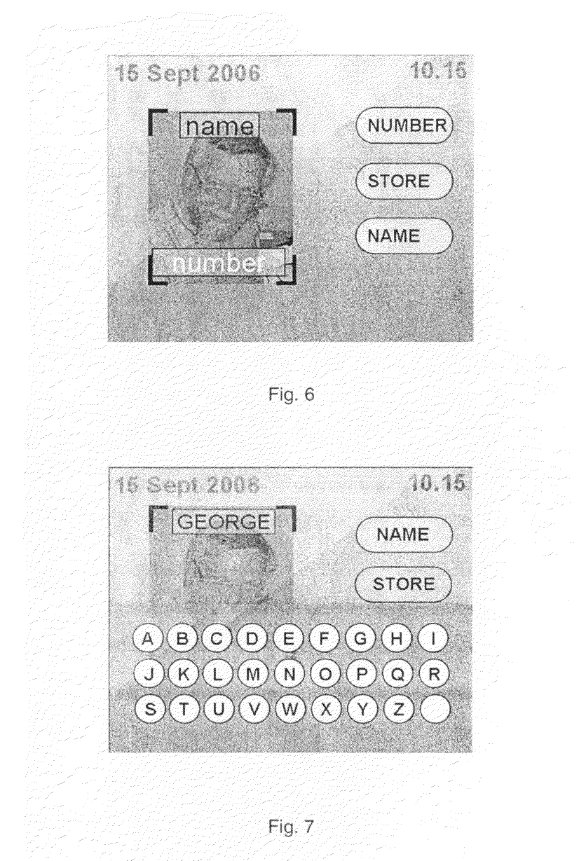

Touching ‘store’ activates the next screen (see FIG. 6) which asks for a number and name. The ‘number’ key is displayed, the number entered from an numeric keypad which appears and is then stored, following which the name is entered using the alpha keypad (see FIG. 7) which is displayed as soon as the ‘name’ key is touched.

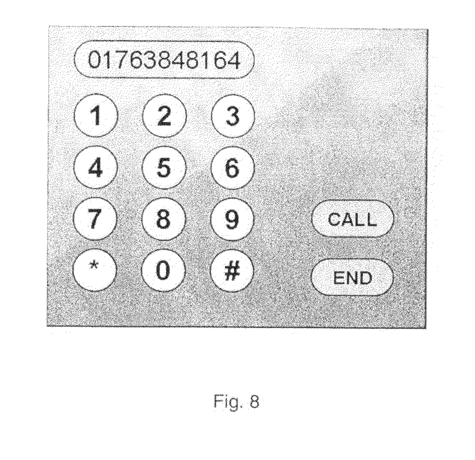

If a call needs to be made to person not stored in the directory then the ‘keypad’ key is touched from the main screen menu bringing up the number key pad (see FIG. 8) which is touched to dial the number.

The phone messaging service may be arranged so that messages can only be left by those callers whose numbers are resident in the picture directory. An installed outgoing voice message (no personal voice message) tells the caller to leave a message. If a message is left then the message LED 124 will flash. This prompts the user to touch the ‘message’ key on the main screen menu.

On touching the message key up to five images are displayed showing the caller, date and time when the message was left. Touching the image will play the message. There is no facility for storing, fast forwarding or deleting. Messages are deleted after 3 plays or 24 hours. When messages have been played or the user wishes to return to the main menu then the ‘end’ key is touched.

If desired, the display may be arranged to display automatically text or picture data sent to the apparatus by a suitable link which may be a broadband link, the apparatus having suitable processing capability to decode a message from one of a number of services pre-selected by means of suitable additional menu options.

The display 18 may be arranged to display a picture associated with the telephone number of an incoming caller when the base station 1 receives a telephone call. This is only possible if the telephone number of the incoming caller and an associated picture are stored in the picture directory.

The base station 1 may be connected to a remote camera and a doorbell that enables a user to see who is at a door. If the doorbell is depressed the remote camera at the door takes a still image of the person at the door. This will then be displayed on the display 18 and users will have the option to let the person in remotely by pressing a button on the telephone.

A Bluetooth unit may be added to the base station 1 and when a paired mobile phone is connected to the base station 1, via a Bluetooth connection, a user will not only be able to see all of their mobile phone contacts on the base station 1 (without having to manually store them) but will be able to make and receive calls via the mobile network, but using the base station 1. This will allow users to use the hands-free functionality provided by the microphone 19 on the base station 1.

1. A telephone apparatus including:
a base station having a connection to a PSTN line;
a handset connectable with the base station and to the PSTN therethrough;
a memory for storing a database of telephone numbers each associatable with a picture;
a processor for downloading a picture to the database;
an input device for associating a picture with a telephone number and saving the telephone number in the database in association with the picture;
a display arranged to display each picture sequentially from the database;
a selector for selecting a picture from the database for display on the display;
a dialling initiator for causing the telephone apparatus to dial the number associated with the picture displayed on the display; and
a digital camera arranged to be docked with the base station for connection thereto, to enable download of pictures stored therein to the database, the digital camera being removable from the base station.

2. A telephone apparatus according to claim 1, wherein the handset has a radio module for connection to the base station via a corresponding radio module.

3. A telephone apparatus according to claim 2, wherein the handset includes a charging connector and a rechargeable battery, the base station including a corresponding charging port to enable charging of the rechargeable battery in the handset when the handset is docked in the base station.

4. A telephone apparatus according to claim 1, wherein the handset has a cable connection to the base station.

5. A telephone apparatus according to claim 1, wherein the memory storing the database is disposed in the base station.

6. A telephone apparatus according to claim 1, wherein the memory is disposed in the handset.

7. A telephone apparatus according to claim 1, wherein a memory containing the database is provided in each of the handset and the base station.

8. A telephone apparatus according to claim 1, wherein the camera is disposed in the handset.

9. A telephone apparatus according to claim 1, wherein the input device comprises a touch-screen facility.

10. A telephone apparatus according to claim 9, wherein the display provides the touch-screen facility.

11. A telephone apparatus according to claim 1, wherein the input device comprises a keypad.

12. A telephone apparatus according to claim 1, wherein the display includes a touch-screen display.

13. A telephone apparatus according to claim 1, wherein the display is disposed in the handset.

14. A telephone apparatus according to claim 1, wherein the display is disposed in the base station.

15. A telephone apparatus according to claim 1, including a second display, one of the displays being disposed in the handset and the other display being disposed in the base station.

16. A telephone apparatus according to claim 1, wherein the selector comprises one or more keys of a keypad.

17. A telephone apparatus according to claim 1, wherein the selector comprises a scroll wheel.

18. A telephone apparatus according to claim 1, wherein the selector includes a scroll function on the touch-screen display.

19. A telephone apparatus according to claim 1, wherein the dialling initiator is a key.

20. A telephone apparatus according to claim 1, wherein the dialling initiator includes a touch-screen.

21. A telephone apparatus according to claim 20, including a keypad for number-initiated dialling.

22. A telephone apparatus according to claim 21, wherein the screen is arranged to display, selectively, a keypad for on-screen touch dialling.

23. A telephone apparatus according to claim 1, wherein the base station includes a data port for external connection to a memory device or computer.

24. A telephone apparatus according to claim 1, including an audible alarm and a key dedicated to an emergency services number, the audible alarm being caused to sound when the key has been pressed for a predetermined period of time.

25. A telephone apparatus according to claim 1, wherein the display is arranged to display each picture and associated telephone number sequentially from the database.
